(19) United States
(12) Patent Application Publication
(10) Pub. No.: US 2024/0150905 A1
(43) Pub. Date: May 9, 2024

(54) WATER ELECTROLYSIS SYSTEM

(71) Applicant: TOYOTA JIDOSHA KABUSHIKI KAISHA, Toyota-shi (JP)

(72) Inventor: Keisuke FUJITA, Toyota-shi (JP)

(73) Assignee: TOYOTA JIDOSHA KABUSHIKI KAISHA, Toyota-shi (JP)

(21) Appl. No.: 18/474,554

(22) Filed: Sep. 26, 2023

(30) Foreign Application Priority Data
Nov. 4, 2022 (JP) 2022-176999

(51) Int. Cl. C25B 1/04; C25B 15/023

(52) U.S. Cl. CPC C25B 1/04; C25B 15/023

(57) ABSTRACT

In the water electrolysis system, when the water electrolysis cell stack is started, hydrogen is circulated through a hydrogen electrode of the water electrolysis cell stack, oxygen or air is circulated through an oxygen electrode of the water electrolysis cell stack, or oxygen or air is circulated through the oxygen electrode when the operation of the water electrolysis cell stack is stopped. A water electrolysis system, wherein an open circuit voltage of the water electrolysis cell stack is measured, and if the open circuit voltage is less than a threshold value, an abnormality is determined.

### CROSS-REFERENCE TO RELATED APPLICATION

This application claims priority to Japanese Patent Application No. 2022-176999 filed on Nov. 4, 2022, incorporated herein by reference in its entirety.

### BACKGROUND

### 1. Technical Field

The present disclosure relates to a water electrolysis system.

### 2. Description of Related Art

Various studies have been made on water electrolysis devices.

For example, Japanese Unexamined Patent Application Publication No. 2013-249508 (JP 2013-249508 A) discloses a technique of monitoring a pressure behavior in a gas pipe generated from a water electrolysis device and determining a gas leak when the pressure behavior is slowly increased or decreased with respect to a pressure behavior in a normal state.

### SUMMARY

In the determination of gas leak, there is an issue that a minute leak of gas cannot be detected by monitoring the pressure behavior.

The present disclosure has been made in view of the above circumstances, and it is a main object of the present disclosure to provide a water electrolysis system capable of detecting a minute leakage of gas.

In a water electrolysis system provided in the present disclosure, when a water electrolysis cell stack is activated, hydrogen is circulated through a hydrogen electrode of the water electrolysis cell stack, and oxygen or air is circulated through an oxygen electrode of the water electrolysis cell stack, or
when an operation of the water electrolysis cell stack is stopped, oxygen or air is circulated through the oxygen electrode; and
an open circuit voltage of the water electrolysis cell stack is measured, and when the open circuit voltage is less than a threshold value, an abnormality is determined to occur.

In the present disclosure, when the water electrolysis cell stack is activated, hydrogen may be circulated through the hydrogen electrode and oxygen or air may be circulated through the oxygen electrode before water electrolysis of the water electrolysis cell stack is started, the open circuit voltage of the water electrolysis cell stack may be measured, and when the open circuit voltage is less than the threshold value, an abnormality may be determined to occur.

In the present disclosure, when the operation of the water electrolysis cell stack is stopped, pure water may be circulated through the oxygen electrode after water electrolysis of the water electrolysis cell stack is stopped, oxygen or air may be circulated through the oxygen electrode after a voltage of the water electrolysis cell stack is lowered to less than the threshold value, the open circuit voltage of the water electrolysis cell stack may be measured, and when the open circuit voltage is less than the threshold value, an abnormality may be determined to occur.

In the present disclosure, the water electrolysis system may include the water electrolysis cell stack, a control unit, and a voltage sensor.

The control unit may store the threshold value.
The voltage sensor may measure the open circuit voltage.
When the water electrolysis cell stack is activated, the control unit may cause hydrogen to be circulated through the hydrogen electrode and oxygen or air to be circulated through the oxygen electrode before water electrolysis of the water electrolysis cell stack is started, and when the open circuit voltage of the water electrolysis cell stack is less than the threshold value, the control unit may determine that an abnormality occurs.
When the operation of the water electrolysis cell stack is stopped, the control unit may cause pure water to be circulated through the oxygen electrode after the water electrolysis of the water electrolysis cell stack is stopped, the control unit may cause oxygen or air to be circulated through the oxygen electrode after a voltage of the water electrolysis cell stack is lowered to less than the threshold value, and when the open circuit voltage of the water electrolysis cell stack is less than the threshold value, the control unit may determine that an abnormality occurs.

The water electrolysis system according to the present disclosure is capable of detecting a minute leakage of gas.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating an example of a flow of oxygen and hydrogen in a water electrolysis system of the present disclosure;

FIG. 2 is a timing diagram illustrating an exemplary relation between time and voltage of a water electrolysis cell stack in sequence control for detecting gas leakage when the water electrolysis cell stack is started; and

FIG. 3 is a timing chart illustrating an example of a relationship between time and a voltage of the water electrolysis cell stack in the sequence control for detecting gas leakage when the operation of the water electrolysis cell stack is stopped.

### DETAILED DESCRIPTION OF EMBODIMENTS

Embodiments according to the present disclosure will be described below. Note that matters other than those specifically mentioned in the present specification and necessary for the implementation of the present disclosure can be understood as design matters of a person skilled in the art based on the prior art in the field. The above is, for example, the general configuration and manufacturing process of a water electrolysis system that does not characterize the present disclosure. The present disclosure may be carried out based on the content disclosed in the present specification and the common general technical knowledge in the field.

In the present specification, “to” indicating a numerical range is used in a sense including numerical values described before and after the numerical range as a lower limit value and an upper limit value.
Any combination of the upper limit value and the lower limit value in the numerical range can be adopted.

The present disclosure provides a water electrolysis system. When the water electrolysis cell stack is started up, hydrogen is circulated through the hydrogen electrode of the water electrolysis cell stack, and oxygen or air is circulated through the oxygen electrode of the water electrolysis cell stack.

When the water electrolysis cell stack is stopped, oxygen or air is circulated through the oxygen electrode.
A water electrolysis system is provided that measures an open circuit voltage of the water electrolysis cell stack and determines an abnormality if the open circuit voltage is less than a threshold value.

Conventional water electrolysis systems detect gas leaks from the pressure behavior of piping. Therefore, it is not possible to distinguish between gas leakage due to a seal failure of a seal portion such as a pipe joint outside the water electrolysis cell stack and gas leakage (gas cross leakage) due to breakage of an electrolyte membrane of the water electrolysis cell. Moreover, from the pressure behavior, it is not possible to detect a minute leak of the gas.

In the present disclosure, since the presence or absence of an abnormality (gas leakage) is determined by the open circuit voltage of the water electrolysis cell stack, it is possible to determine only the gas leakage caused by the breakage of the electrolyte membrane of the water electrolysis cell. In addition, in the present disclosure, since the presence or absence of an abnormality is determined by the open circuit voltage of the water electrolysis cell stack, it is possible to detect a minute leakage of gas.

### When Starting the Water Electrolysis Cell Stack

In the water electrolysis system of the present disclosure, when the water electrolysis cell stack is started up, hydrogen is caused to flow through the hydrogen electrode of the water electrolysis cell stack, oxygen or air is caused to flow through the oxygen electrode of the water electrolysis cell stack, the open circuit voltage of the water electrolysis cell stack is measured, and if the open circuit voltage is less than the threshold value, it is determined that an abnormality, that is, gas leakage occurs.

In the present disclosure, from the viewpoint of improving the accuracy of the abnormality determination, when the water electrolysis cell stack is started up, hydrogen is caused to flow through the hydrogen electrode before the start of the water electrolysis of the water electrolysis cell stack, oxygen or air is caused to flow through the oxygen electrode, the open circuit voltage of the water electrolysis cell stack is measured, and if the open circuit voltage is less than the threshold value, an abnormality may be determined.

### When the Water Electrolysis Cell Stack is Shut Down

In the water electrolysis system of the present disclosure, when the operation of the water electrolysis cell stack is stopped, oxygen or air is caused to flow through the oxygen electrode of the water electrolysis cell stack, the open circuit voltage of the water electrolysis cell stack is measured, and if the open circuit voltage is less than the threshold value, an abnormality is determined.

In the present disclosure, from the viewpoint of improving the accuracy of the abnormality determination, when the operation of the water electrolysis cell stack is stopped, pure water is caused to flow through the oxygen electrode of the water electrolysis cell stack after the water electrolysis of the water electrolysis cell stack is stopped, and after the voltage of the water electrolysis cell stack is lowered to less than the threshold value, oxygen or air is caused to flow through the oxygen electrode of the water electrolysis cell stack, the open circuit voltage of the water electrolysis cell stack is measured, and if the open circuit voltage is less than the threshold value, an abnormality may be determined.
When the operation of the water electrolysis cell stack is stopped, pure water is caused to flow only through the oxygen electrode, the potential of the oxygen electrode is lowered, and then oxygen or air is caused to flow through the oxygen electrode. When oxygen or air is circulated through the oxygen electrode, it is not necessary to circulate hydrogen through the hydrogen electrode.

The water electrolysis system of the present disclosure may include a water electrolysis cell stack, a control unit, and a voltage sensor.

The water electrolysis system may further include an aqueous system, a hydrogen system, and an oxygen-containing gas system.

The water system may include a water supply unit, a water supply channel, and the like.

The water supply flow path connects the water supply portion and the oxygen electrode of the water electrolysis cell stack. The water supply unit supplies water, pure water, and the like to the oxygen electrode of the water electrolysis cell stack via the water supply flow path.

The hydrogen system may include a hydrogen electrode-side gas-liquid separator, a hydrogen storage tank, a hydrogen recovery channel, a hydrogen supply channel, and the like.

The hydrogen electrode-side gas-liquid separator is disposed on the hydrogen recovery flow path. The hydrogen electrode-side gas-liquid separator separates hydrogen and moisture from a hydrogen-containing gas containing moisture generated by water electrolysis. The dried hydrogen separated by the hydrogen electrode-side gas-liquid separator may be sent to a hydrogen storage tank. The water separated by the hydrogen electrode-side gas-liquid separator may be sent to a water supply unit.
The hydrogen storage tank stores hydrogen generated by water electrolysis.
The hydrogen supply channel connects the hydrogen storage tank and the hydrogen electrode of the water electrolysis cell stack. When the water electrolysis cell stack is activated, hydrogen may flow from the hydrogen storage tank to the hydrogen electrode of the water electrolysis cell stack. Hydrogen generated by water electrolysis can be used as hydrogen flowing through the water electrolysis cell stack to determine the presence or absence of abnormality.

The oxygen-containing gas system may include an oxygen electrode-side gas-liquid separator, an oxygen-containing gas storage tank, an oxygen recovery channel, an oxygen supply channel, and the like.

The oxygen electrode-side gas-liquid separator is disposed on the oxygen recovery flow path. The oxygen electrode-side gas-liquid separator separates oxygen and moisture from an oxygen-containing gas containing moisture generated by water electrolysis. The dried oxygen separated by the oxygen electrode-side gas-liquid separator may be sent to an oxygen-containing gas storage tank or may be exhausted to the outside of the water electrolysis system. The moisture separated by the oxygen electrode-side gas-liquid separator may be sent to the water supply unit, or may be sent from the oxygen supply flow path to the oxygen electrode of the water electrolysis cell stack.
The oxygen-containing gas storage tank stores oxygen-containing gases such as oxygen and air.
The oxygen supply flow path connects the oxygen-containing gas storage tank and the oxygen electrode of the water electrolysis cell stack. When the water electrolysis cell stack is activated, oxygen or air may flow from the oxygen-containing gas storage tank to the oxygen electrode of the water electrolysis cell stack. The oxygen-containing gas flowing through the water electrolysis cell stack for the determination of the presence or absence of the abnormality can use the oxygen generated by the water electrolysis.

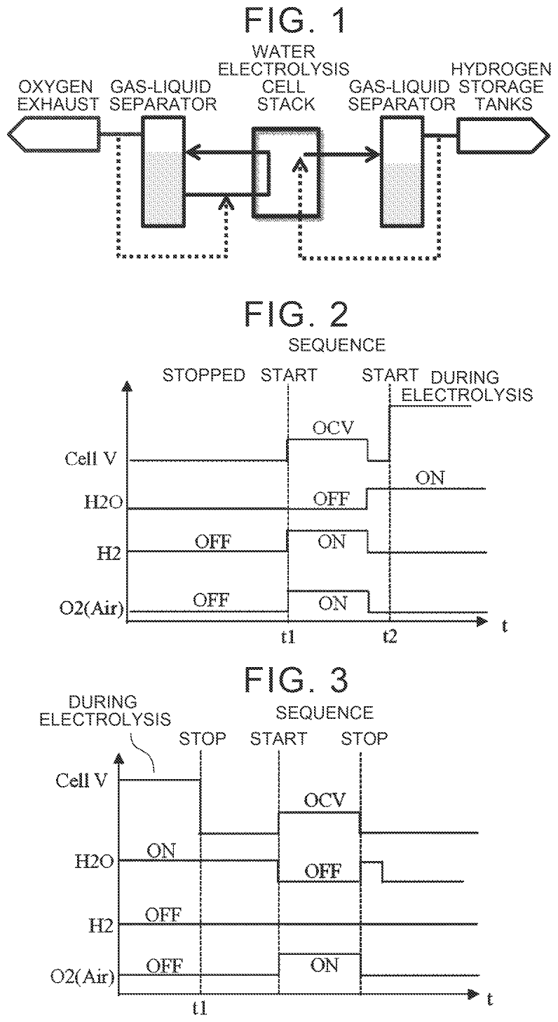

FIG. 1 is a schematic configuration diagram illustrating an example of a flow of oxygen and hydrogen in a water electrolysis system of the present disclosure. Note that the water electrolysis system of the present disclosure is not limited to the configuration shown in FIG. 1.

The water electrolysis system shown in FIG. 1 includes a water electrolysis cell stack, a hydrogen electrode-side gas-liquid separator, a hydrogen storage tank, and an oxygen electrode-side gas-liquid separator. Note that other configurations are omitted for convenience.
The hydrogen-containing gas generated by the water electrolysis of the water electrolysis cell stack contains moisture. The gas is separated into hydrogen and water by a hydrogen electrode-side gas-liquid separator. The hydrogen separated by the hydrogen electrode-side gas-liquid separator is sent to a hydrogen storage tank. When the water electrolysis cell stack is started up, the hydrogen stored in the hydrogen storage tank can be circulated to the hydrogen electrode of the water electrolysis cell stack in order to determine the presence or absence of an abnormality.
The oxygen-containing gas generated by the water electrolysis contains moisture. The gas is separated into oxygen and moisture by an oxygen electrode-side gas-liquid separator. The oxygen separated by the oxygen electrode-side gas-liquid separator can be exhausted to the outside of the water electrolysis system. In addition, at least a portion of the oxygen may be circulated and supplied to the oxygen electrode of the water electrolysis cell stack. In this configuration, a switching valve for switching between the exhaust gas and the circulation supply may be provided in the oxygen recovery flow path. The water separated by the oxygen electrode-side gas-liquid separator can be supplied to the oxygen electrode of the water electrolysis cell stack. In this configuration, a switching valve for switching between the supply of moisture and the supply of oxygen may be provided in the oxygen supply flow path.

The water electrolysis cell stack is a stacked body formed by stacking a plurality of water electrolysis cells.

The number of stacked water electrolysis cells is not particularly limited, and may be, for example, 2 to several hundred.
The water electrolysis cell of the present disclosure electrolyzes the water supplied to the anode (oxygen electrode) as follows. Oxygen is generated from the anode, and hydrogen is generated from the cathode (hydrogen electrode).

H₂O→2H⁺+½O₂+2e⁻ Anode:

2H⁺+2e⁻>H₂ Cathode:

The water electrolysis cell may include two separators having at least an electrode portion and sandwiching the electrode portion as necessary.
The electrode portion includes an anode-side gas diffusion layer, an anode catalyst layer, an electrolyte membrane, a cathode catalyst layer, and a cathode-side gas diffusion layer in this order.
The cathode (hydrogen electrode) includes a cathode catalyst layer and a cathode-side gas diffusion layer.

The anode (oxygen electrode) includes an anode catalyst layer and an anode-side gas diffusion layer.

The cathode catalyst layer and the anode catalyst layer are collectively referred to as a catalyst layer.

The catalyst layer may include, for example, a catalyst metal that promotes water electrolysis, an electrolyte having proton conductivity, a support having electron conductivity, and the like.
As the catalytic metal, for example, iridium (Ir), iridium dioxide (IrO₂), ruthenium (Ru), platinum (Pt), and an alloy composed of Pt and another metal (for example, a Pt alloy obtained by mixing cobalt, nickel, and the like) can be used. As the anode catalyst layer, for example, Ir, iridium dioxide (IrO₂), Ru, or the like may be used as the catalyst metal, and as the catalyst metal, for example, Pt, and Pt alloy, or the like may be used as the cathode catalyst layer.
The electrolyte may be fluorine-based resin or the like. As the fluorine-based resin, for example, Nafion solution or the like may be used.
The catalyst metal is supported on a carrier, and each catalyst layer may contain a mixture of a carrier supporting the catalyst metal (catalyst-supporting carrier) and an electrolyte.
Examples of the carrier for supporting the catalyst metal include commercially available carbon materials such as carbon.

The electrolyte membrane may be a solid polymer electrolyte membrane. Examples of the solid polymer electrolyte membrane include fluorine-based electrolyte membranes such as perfluorosulfonic acid thin films containing water, and hydrocarbon-based electrolyte membranes. As the electrolyte membrane, for example, a Nafion membrane (produced by DuPont) may be used.

The cathode-side gas diffusion layer and the anode-side gas diffusion layer are collectively referred to as a gas diffusion layer (GDL).

The gas diffusion layer may be a gas permeable, that is, a conductive member having pores. Examples of the electroconductive member include porous carbon bodies such as carbon cloth and carbon paper, and porous metal bodies such as metal mesh and metal foam.

The anode separator and the cathode separator are collectively referred to as a separator. The cathode separator is disposed adjacent to a surface of the cathode-side gas diffusion layer opposite to the cathode catalyst layer. The anode separator is disposed adjacent to a surface of the anode-side gas diffusion layer opposite to the anode catalyst layer. Two separators, an anode separator and a cathode separator, sandwich the resin frame and the electrode portion.

The separator may have holes such as a supply hole and a discharge hole. These holes allow a fluid such as reaction water, oxygen, hydrogen, and a cooling medium to flow in the stacking direction of the water electrolysis cell. As the reaction water and the cooling medium, water, pure water, or the like can be used.
Examples of the supply hole include an anode supply hole, a cathode supply hole, and a cooling medium supply hole.
Examples of the discharge hole include an anode discharge hole, a cathode discharge hole, and a cooling medium discharge hole.
The separator may have a flow path of a reaction fluid such as reaction water, oxygen, or hydrogen on a surface in contact with the gas diffusion layer. In addition, the separator may have a flow path of a cooling medium for keeping the temperature of the water electrolysis cell constant on the surface opposite to the surface in contact with the gas diffusion layer.
The anode separator may have a flow path of an anode fluid such as reactive water or oxygen on a surface in contact with the anode-side gas diffusion layer. In addition, the anode separator may have a flow path of a cooling medium for keeping the temperature of the water electrolysis cell constant on the surface opposite to the surface in contact with the anode-side gas diffusion layer.
The cathode separator may have a flow path of a cathode fluid such as hydrogen on a surface in contact with the cathode-side gas diffusion layer. In addition, the cathode separator may have a flow path of the cooling medium on a surface opposite to the surface in contact with the cathode-side gas diffusion layer. The cooling medium keeps the temperature of the water electrolysis cell constant.
The separator may be a gas-impermeable electroconductive member or the like. The conductive member may be, for example, dense carbon obtained by compressing a resin material such as a thermosetting resin, a thermoplastic resin, and a resin fiber, and a carbon material such as a carbon powder and a carbon fiber to make it gas impermeable, and a press-molded metal (for example, titanium, stainless steel, and the like) plate.
The shape of the separator may be a rectangle, a horizontally long hexagon, a horizontally long octagon, a circle, an oblong shape, and the like.

The water electrolysis cell may typically comprise a resin frame.

The resin frame is disposed on the outer periphery of the electrode portion and is disposed between the cathode separator and the anode separator.
The resin frame may have a framework portion, an opening portion, and a hole.
The skeleton portion is a main portion of the resin frame connected to the electrode portion. The opening portion is a holding region of the electrode portion. The opening is a region that penetrates a portion of the skeleton portion to accommodate the electrode portion. The opening portion may be disposed at a position where the skeleton portion is disposed in the periphery (outer peripheral portion) of the electrode portion in the resin frame, and may be provided at the center of the resin frame.
The holes of the resin frame allow a fluid such as reaction water, oxygen, hydrogen, and a cooling medium to flow in the stacking direction of the water electrolysis cell. The holes in the resin frame may be aligned and arranged to communicate with the holes in the separator. The resin frame may include a frame-shaped core layer and two frame-shaped shell layers provided on both sides of the core layer, that is, a first shell layer and a second shell layer.
The first shell layer and the second shell layer may be provided in a frame shape on both sides of the core layer, similarly to the core layer.

The core layer may be any structural member having gas sealing properties and insulating properties. The core layer may be formed of a material whose structure does not change even under a temperature condition at the time of thermocompression bonding in the manufacturing process of the water electrolysis cell. Specifically, the material of the core-layer may be, for example, a resin such as polyethylene, polypropylene, polycarbonate (PC), polyphenylene sulfide (PPS), polyethylene terephthalate (PET), polyethylene naphthalate (PEN), polyamide (PA), polyimide (PI), polystyrene (PS), polyphenylene ether (PPE), polyether ether ketone (PEEK), cycloolefin, polyether sulfone (PES), polyphenyl sulfone (PPSU), liquid crystal polymer (LCP), or epoxy resin. The core-layer material may be a rubber material such as ethylene propylene diene rubber (EPDM), fluorine-based rubber, or silicone-based rubber.

From the viewpoint of ensuring the insulating property, the thickness of the core layer may be 5 μm or more or 20 μm or more. From the viewpoint of reducing the thickness of the water electrolysis cell, the thickness of the core layer may be 200 μm or less, or 150 μm or less.

The first shell layer and the second shell layer may have a high adherence property to other materials, have a property of softening under a temperature condition during thermocompression bonding and having a lower viscosity and melting point than the core layer, in order to adhere the core layer with the anode separator and the cathode separator and ensure a sealing performance. Specifically, the first shell layer and the second shell layer may be thermoplastic resins such as polyester-based and modified olefin-based resins. The first shell layer and the second shell layer may be thermosetting resins that are modified epoxy resins.

The resin that constitutes the first shell layer and the resin that constitutes the second shell layer may be the same type of resin or different types of resin. By providing the shell layers on both sides of the core layer, it becomes easier to adhere the resin frame and the two separators by hot pressing.
From the viewpoint of ensuring adhesion, the thickness of the shell layer of each of the first shell layer and the second shell layer may be 5 μm or more and may be 30 μm or more. From the viewpoint of reducing the thickness of the water electrolysis cell, the thickness of the shell layer of each of the first shell layer and the second shell layer may be 100 μm or less and may be 40 μm or less.

In the resin frame, the first shell layer and the second shell layer may be provided only on the portions to be adhered to the anode separator and the cathode separator, respectively. The first shell layer provided on one side of the core layer may be adhered to the cathode separator. The second shell layer provided on the other side of the core layer may be adhered to the anode separator. Then, the resin frame may be sandwiched between the pair of separators.

The water electrolysis cell stack may include a manifold such as an inlet manifold in which the supply holes communicate with each other and an outlet manifold in which the discharge holes communicate with each other.

Inlet manifolds include anode inlet manifolds, cathode inlet manifolds, and cooling medium inlet manifolds.
Outlet manifolds include anode outlet manifolds, cathode outlet manifolds, and cooling medium outlet manifolds.

The voltage sensor measures the open circuit voltage of the water electrolysis cell stack.

The voltage sensor is electrically connected to the control unit. The control unit detects an open circuit voltage of the water electrolysis cell stack acquired by the voltage sensor.
As the voltage sensor, a conventionally known voltmeter or the like can be used.

The control unit controls the operation of the water electrolysis cell and determines whether an abnormality, that is, whether or not gas leakage occurs.

The control unit physically includes, for example, an arithmetic processing unit such as a central processing unit (CPU), a read-only memory (ROM) that stores control programs and control data to be processed by CPU, a storage device such as a random access memory (RAM) that is mainly used as various working areas for the control processing, and an input/output interface. The control unit may be, for example, a control device such as Electronic Control Unit (ECU).
The control unit stores the threshold value of the water electrolysis cell stack in advance.
The threshold value of the water electrolysis cell stack may be set from the data group of the open circuit voltage of the water electrolysis cell stack in a state in which no gas leakage occurs, that is, in a normal state.

The control unit may execute the following control.

At the time of starting the water electrolysis cell stack, the control unit may flow hydrogen to the hydrogen electrode before starting the water electrolysis of the water electrolysis cell stack, and flow oxygen or air to the oxygen electrode, and when the open circuit voltage of the water electrolysis cell stack is less than the threshold value, the control unit may determine that an abnormality has occurred.
When the operation of the water electrolysis cell stack is stopped, the control unit causes pure water to flow through the oxygen electrode after the water electrolysis of the water electrolysis cell stack is stopped, and causes the voltage of the water electrolysis cell stack to decrease to less than the threshold value, and then, the control unit causes oxygen or air to flow through the oxygen electrode, and when the open circuit voltage of the water electrolysis cell stack is less than the threshold value, the control unit may determine that an abnormality is present.

### First Embodiment

### When Starting the Water Electrolysis Cell Stack

FIG. 2 is a timing chart illustrating an example of a relationship between time and a voltage of a water electrolysis cell stack in sequence control for detecting gas leakage when the water electrolysis cell stack is started.
1. Prior to the water electrolysis, the voltage of the water electrolysis cell stack (referred to as CellV in FIG. 2) is 0V.
2. When the water electrolysis cell stack is activated, the control unit starts a sequence for detecting gas leakage.
3. Hydrogen is passed through the hydrogen electrode, oxygen or air is passed through the oxygen electrode, and the open circuit voltage (OCV) of the water electrolysis cell stack is measured.
4. At this time, the control unit determines whether OCV is less than the threshold value.
5. After OCV is detected, the control unit stops the flow of hydrogen-oxygen or air.
6. When OCV is greater than or equal to the threshold value, the control unit causes pure water to flow through the oxygen electrode, and starts water electrolysis. If OCV is less than the threshold value, the control unit displays an alarm and makes it impossible to initiate water electrolysis.

### Second Embodiment

### When the Water Electrolysis Cell Stack is Shut Down

FIG. 3 is a timing chart illustrating an example of a relationship between time and a voltage of the water electrolysis cell stack in the sequence control for detecting gas leakage when the operation of the water electrolysis cell stack is stopped.
1. After the water electrolysis is stopped, pure water is continuously circulated through the oxygen electrode.
2. As a result of 1. above, the voltages of the respective water electrolysis cells of the water electrolysis cell stack (referred to as CellV in FIG. 3) decrease.
3. Thereafter, the flow of pure water to the oxygen electrode is stopped, and oxygen or air is allowed to flow to the oxygen electrode.
4. Determine whether OCV of the water electrolysis cell stack raised according to 3. above is less than the threshold value.
5. After OCV is detected, the flow of oxygen or air to the oxygen electrode is stopped.
6. Then, in order to prevent oxygen from leaking to the hydrogen electrode, pure water is circulated through the oxygen electrode again, and the gas is stopped after a predetermined time.
7. If OCV in 4. above is less than the threshold value and is determined to be abnormal, an alarm is displayed.

What is claimed is:

1. A water electrolysis system, wherein:
when a water electrolysis cell stack is activated, hydrogen is circulated through a hydrogen electrode of the water electrolysis cell stack, and oxygen or air is circulated through an oxygen electrode of the water electrolysis cell stack, or
when an operation of the water electrolysis cell stack is stopped, oxygen or air is circulated through the oxygen electrode; and
an open circuit voltage of the water electrolysis cell stack is measured, and when the open circuit voltage is less than a threshold value, an abnormality is determined to occur.

2. The water electrolysis system according to claim 1, wherein when the water electrolysis cell stack is activated, hydrogen is circulated through the hydrogen electrode and oxygen or air is circulated through the oxygen electrode before water electrolysis of the water electrolysis cell stack is started, the open circuit voltage of the water electrolysis cell stack is measured, and when the open circuit voltage is less than the threshold value, an abnormality is determined to occur.

3. The water electrolysis system according to claim 1, wherein when the operation of the water electrolysis cell stack is stopped, pure water is circulated through the oxygen electrode after water electrolysis of the water electrolysis cell stack is stopped, oxygen or air is circulated through the oxygen electrode after a voltage of the water electrolysis cell stack is lowered to less than the threshold value, the open circuit voltage of the water electrolysis cell stack is measured, and when the open circuit voltage is less than the threshold value, an abnormality is determined to occur.

4. The water electrolysis system according to claim 1, wherein:
the water electrolysis system includes the water electrolysis cell stack, a control unit, and a voltage sensor;
the control unit stores the threshold value;
the voltage sensor measures the open circuit voltage;
when the water electrolysis cell stack is activated, the control unit causes hydrogen to be circulated through the hydrogen electrode and oxygen or air to be circulated through the oxygen electrode before water electrolysis of the water electrolysis cell stack is started, and when the open circuit voltage of the water electrolysis cell stack is less than the threshold value, the control unit determines that an abnormality occurs; and
when the operation of the water electrolysis cell stack is stopped, the control unit causes pure water to be circulated through the oxygen electrode after the water electrolysis of the water electrolysis cell stack is stopped, the control unit causes oxygen or air to be circulated through the oxygen electrode after a voltage of the water electrolysis cell stack is lowered to less than the threshold value, and when the open circuit voltage of the water electrolysis cell stack is less than the threshold value, the control unit determines that an abnormality occurs.
